(19) United States
(12) Patent Application Publication
(10) Pub. No.: US 2009/0242726 A1
(43) Pub. Date: Oct. 1, 2009

(54) SOUND-INSULATING ASSEMBLY ELEMENT FOR SUPPORTING PROFILES

(75) Inventor: Patrick Carels, Ovrijse (BE)

Correspondence Address: BROWDY AND NEIMARK, P.L.L.C.;624 NINTH STREET, NW, SUITE 300, WASHINGTON, DC, 20001-5303, US

(73) Assignee: COMPOSITE DAMPING MATERIAL N.V., Overijse (BE)

(21) Appl. No.: 12/413,769

(22) Filed: Mar. 30, 2009

(30) Foreign Application Priority Data
Mar. 28, 2008 (BE) 20080196

(51) Int. Cl. F16M 13/00

(52) U.S. Cl. 248/562

(57) ABSTRACT

Assembly element for fixing a supporting profile on a solid ground with at least two opposite, outward turned flanges extending in the longitudinal direction of said supporting profile, whereby this assembly element comprises an elastic, compressible vibration isolator with a slot in which can be put a flange of the supporting profile, such that the supporting profile is acoustically insulated in relation to the ground, whereby the vibration isolator is formed of at least two parts defining the slot and which allow the vibration isolator to assume an open position, whereby the parts of the vibration isolator are at least partly removed from one another so as to put the flange of the supporting profile at least partly in the slot, and to assume a closed position, whereby the above-mentioned parts are moved towards one another and the vibration isolator is compressed so as to press together the slot when the flange of the supporting profile is at least partly situated inside the slot, such that the flange is clamped in said slot.

The invention concerns an assembly element for fixing a supporting profile on a solid ground with at least two opposite, outward turned flanges extending in the longitudinal direction of said supporting profile, whereby this assembly element comprises an elastic, compressible vibration isolator with a slot in which can be put a flange of the supporting profile, such that the supporting profile is acoustically insulated in relation to the ground.

These supporting profiles can be, for instance, steel profiles or metal hat shaped furring channels for mounting ceiling or wall boards on a solid ground or support structure.

The assembly elements of this type known at present for fixing such supporting profiles, such as for example a profile with an omega-shaped cross section, are formed of a metal, C-shaped bracket with a sound-deadening element therein formed of vulcanised material with a slot in which fit two flanges extending in the longitudinal direction of the supporting profile. The bracket is fixed to the solid ground by means of conventional fixing means, such as screws.

Such assembly elements are disadvantageous among others in that the slot must have sufficient free space between the supporting profile and the sound-deadening element to make it possible for the flanges of the supporting profile to be placed in the slot. Consequently, the supporting profile has quite a lot freedom of movement inside the slot. Moreover, the vulcanised material is quite rigid, as a result of which the dynamic rigidity is high and the vibration isolation is restricted.

Further, the vibration-isolating element in the metal bracket has a rather complex design since it has to connect to the bracket on the one hand, and since it must have a slot on the other hand in which the two flanges of the supporting profile must fit. Such elements with a complex design must be manufactured, for example, by means of extrusion. Thus, an extruded rubber element may be used.

Moreover, the assembly of the supporting profile in such an assembly element with a C-shaped bracket is not so simple, since some dexterity is required to insert the flanges in the slots of the sound-deadening element. Thus, the supporting profile must be transformed or twisted somewhat.

Also, the invention mainly aims to remedy said rather major disadvantages by providing an assembly element which allows for a better vibration isolation on the one hand, and which is quite simple to manufacture and to assemble on the other hand.

To this aim, the invention provides an assembly element as claimed in the accompanying claims, whereby the vibration isolator is formed of at least two parts defining the slot and which allow the vibration isolator to assume an open position, whereby the parts of the vibration isolator are at least partly removed from one another so as to put the flange of the supporting profile at least partly in the slot, and to assume a closed, compressed position, whereby the above-mentioned parts are moved towards one another and the vibration isolator is compressed so as to press together the slot when the flange of the supporting profile is at least partly situated inside the slot, such that the flange is clamped in said slot, whereby the assembly element further has a base with which it is to rest on the ground and which connects onto a first part of the parts of the vibration isolator, and whereby the assembly element has a distribution plate on the side opposite said base which connects onto a second part of the parts of the vibration isolator, such that these parts extend at least partly between the base and the distribution plate, and are compressed between the base and the distribution plate by means of clamping means in the closed, compressed position.

Practically, the assembly element is provided with a supporting member extending between the distribution plate and the basis and which forms a spacer sleeve between the distribution plate and the basis when the vibration isolator is at least partly compressed, such that the distribution plate cannot move any further towards the base.

According to an advantageous embodiment of the invention, the vibration isolator has a slot side via which the flange of the supporting profile is at least partly introduced in the slot whereby, in the compressed position of the vibration isolator, the compression gradually increases towards the slot side.

According to a special embodiment of the invention, the first part and the second part of the vibration isolator are connected to one another by means of a hinge, such that these parts rotate in relation to one another over an axis from the open position into the closed position, and vice versa.

According to a more special embodiment of the invention, the distribution plate is inclined on the base of the vibration isolator when compressed, as a result of which the compression of the vibration isolator gradually increases in the direction of the decreasing distance between the distribution plate and the base of the vibration isolator.

In a preferred embodiment of the invention, the assembly element is provided with two vibration isolators which connect onto the base via a base or mounting plate and which are fixed to the latter, such that the slots of the vibration isolators are opposed so that they can at least partly enclose two opposite flanges, extending in the longitudinal direction of the supporting profile, whereby the base plate further works in conjunction with the distribution plate so as to compress the vibration isolator between the distribution plate and the base plate by means of the clamping means.

Further, the invention also concerns a method for fixing a supporting profile to the ground with two flanges extending in the longitudinal direction of the profile which are turned away from one another. In this method, the flanges are placed against a side of a first part of a vibration isolator which is formed of elastic compressible material, situated opposite a base. Next, a second part of the vibration isolator is placed against the first part and at least partly against the flanges, such that a slot is formed between the first and the second part in which the flanges are at least partly situated. The vibration isolator is compressed by moving a distribution plate to the base by means of clamping means, which distribution plate connects onto the second part on one side of the vibration isolator which is situated opposite the base.

In particular, the invention also concerns a method whereby the vibration isolator is compressed gradually harder towards the flanges of the supporting profile.

Other particularities and advantages of the invention will become clear from the following description of a few specific embodiments of the invention, with reference to the accompanying figures; this description and the figures do not restrict the scope of the invention in any way, but they are merely given as an example to illustrate the invention.

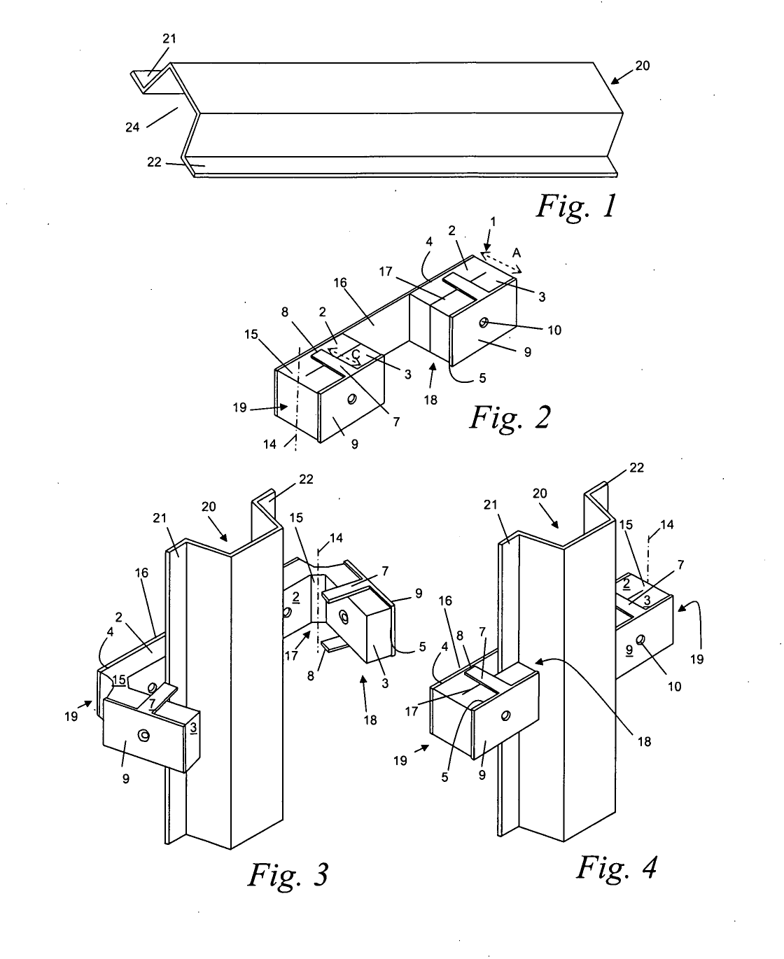

FIG. 1 is a schematic representation of a view in perspective of a supporting profile with two flanges extending in the longitudinal direction of the profile.

FIG. 2 is a schematic representation of a view in perspective of a first embodiment of an assembly element according to the invention with two vibration isolators which are connected to one another by means of the assembly element and whereby each vibration isolator is formed of two parts which are partly connected to one another.

FIG. 3 is a schematic representation of a view in perspective of the first embodiment of an assembly element with a supporting profile according to the invention whereby the vibration isolators are in an open position.

FIG. 4 is a schematic representation of a view in perspective of the first embodiment of an assembly element with a supporting profile according to the invention whereby the vibration isolators are in a closed position.

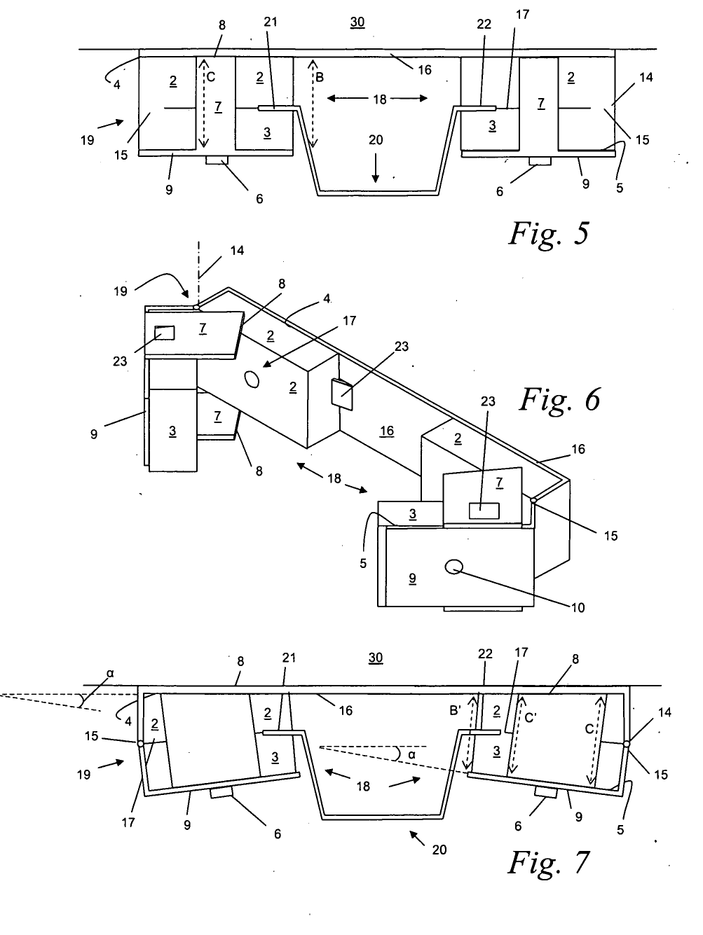

FIG. 5 is a schematic representation of a side elevation of the first embodiment of an assembly element as in FIG. 4.

FIG. 6 is a schematic representation of a view in perspective of a second embodiment of an assembly element according to the invention whereby the vibration isolator is formed of two parts which are hinge-mounted and whereby two vibration isolators are in an open position.

FIG. 7 is a schematic representation of a side elevation of a second embodiment of an assembly element with a supporting profile whereby the vibration isolators are in a closed position.

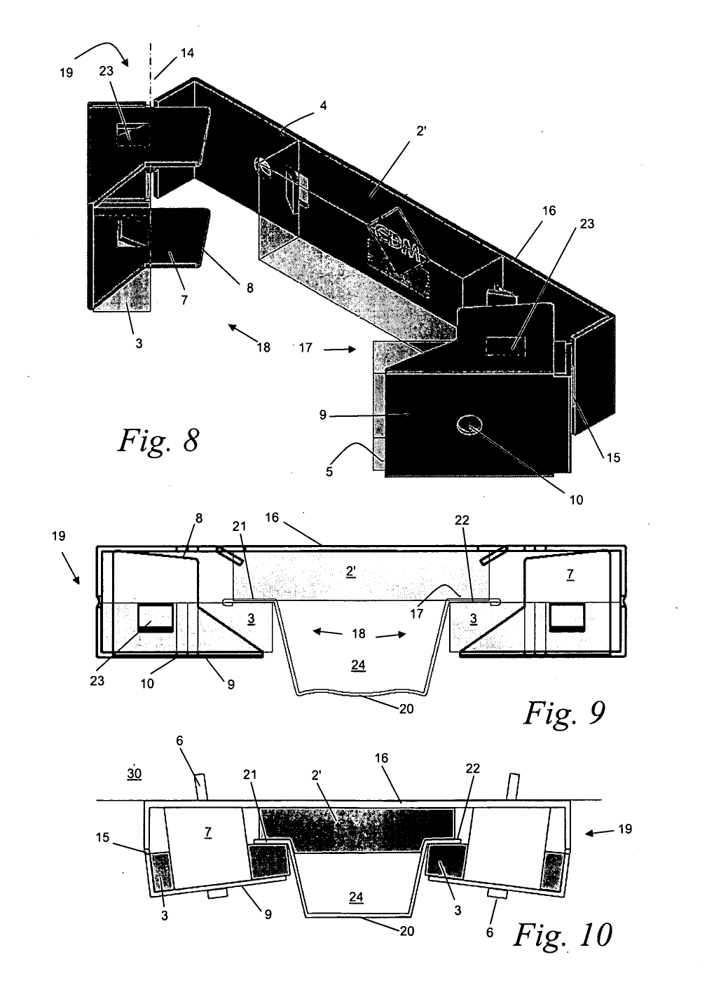

FIG. 8 is a schematic representation of a view in perspective of a ninth embodiment of an assembly element according to the invention whereby the vibration isolators are formed of two parts, one part of which is a common one, and whereby they are in an open position.

FIG. 9 is a schematic representation of a side elevation of the ninth embodiment of an assembly element with a supporting profile whereby the vibration isolators are in a closed position.

FIG. 10 is a schematic representation of a side elevation of a variant of the ninth embodiment of an assembly element with a supporting profile whereby the common part of the vibration isolators has a thickening extending in the cavity of the supporting profile.

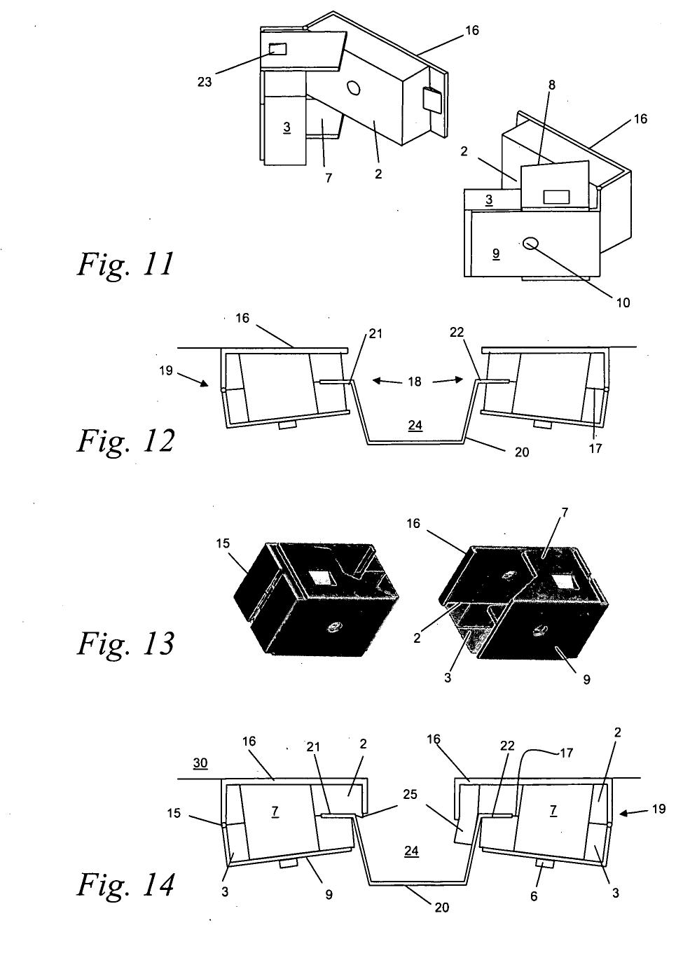

FIG. 11 is a schematic representation of a view in perspective of a tenth embodiment of an assembly element whereby the vibration isolators are not connected to one another.

FIG. 12 is a schematic representation of a side elevation of the tenth embodiment of an assembly element with a supporting profile whereby the vibration isolators are in a closed position.

FIG. 13 is a schematic representation of a view in perspective of the tenth embodiment of an assembly element.

FIG. 14 is a schematic representation of a side elevation of a variant of the tenth embodiment of an assembly element with a supporting profile whereby the vibration isolators are in a closed position and whereby the vibration isolator extends in the cavity of the supporting profile.

FIG. 15 is a schematic representation of a side elevation of an eleventh embodiment of an assembly element with a central fastening point and a snap-in system, whereby the vibration isolators are in a closed position.

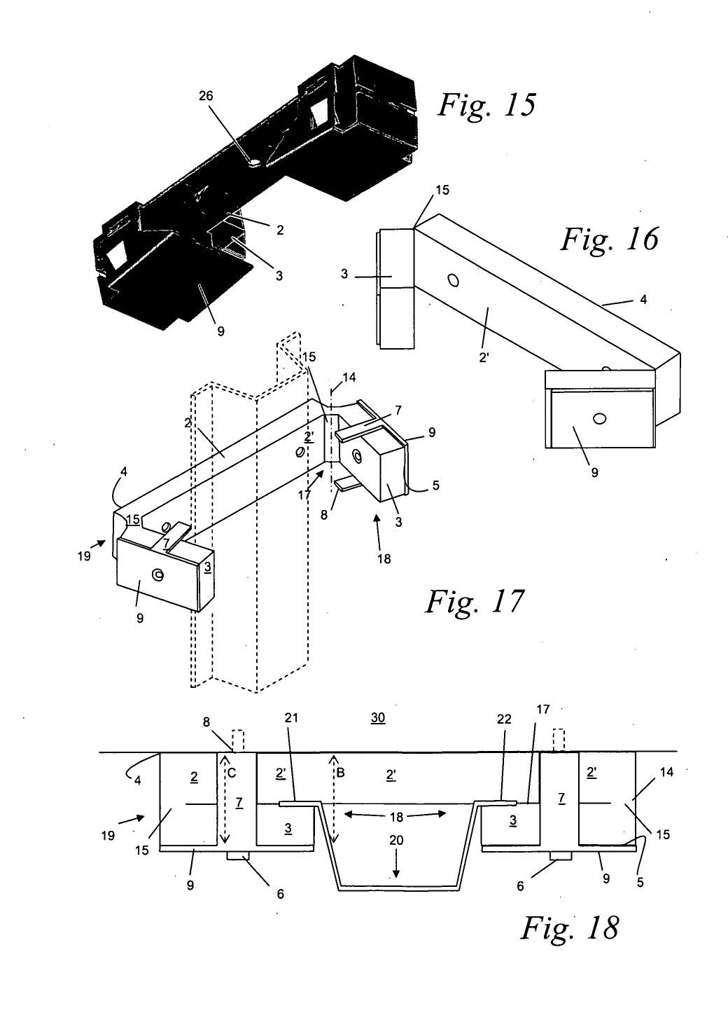

FIG. 16 is a schematic representation of a view in perspective of a twelfth embodiment of an assembly element whereby the vibration isolators have a common part whose far ends are each partly connected with one of the other parts of the vibration isolators.

FIG. 17 is a schematic representation of a view in perspective of the twelfth embodiment of an assembly element whereby the vibration isolators are in an open position.

FIG. 18 is a schematic representation of a side elevation of the twelfth embodiment of an assembly element with a supporting profile whereby the vibration isolators are in a closed position.

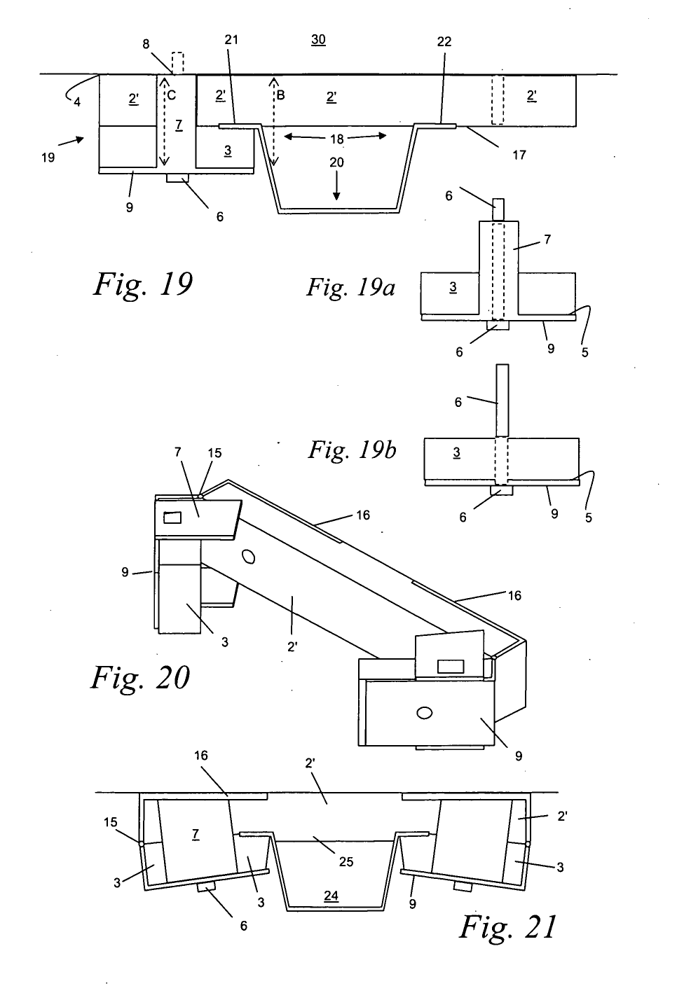

FIG. 19 is a schematic representation of a side elevation of variants of the twelfth embodiment of an assembly element whereby the common part is entirely detached from the other parts of the vibration isolators.

FIG. 20 is a schematic representation of a view in perspective of a thirteenth embodiment of an assembly element whereby the vibration isolators have a common part which connects said vibration isolators to one another.

FIG. 21 is a schematic representation of a side elevation of the thirteenth embodiment of an assembly element with a supporting profile, whereby the common part of the vibration isolators has a thickening extending in the cavity of the supporting profile.

In these figures, the same figures of reference refer to identical or analogous parts.

In general, the invention concerns an assembly element which is mainly designed to fix supporting profiles for ceiling, wall and floor plates to a ground in such a manner that these supporting profiles and the ceiling, wall or floor plates fixed to the latter are acoustically insulated in relation to said ground.

A first embodiment of the assembly element according to the invention is represented in FIGS. 2 to 5, and it is designed to fix a supporting profile 20 with an omega-shaped cross section with two opposite, longitudinal flanges 21 and 22 extending crosswise to a solid ground as shown in FIG. 1. Contrary to a supporting profile with a C-shaped section, not shown in the figures, the flanges 21 and 22 are turned away from each other with this supporting profile 20 and they are turned outward. Between the flanges 21 and 22, this supporting profile has a cavity 24 on the inside. The assembly element has a rectangular, flat, metal base plate 16 or mounting plate onto which are provided two vibration isolators 1 which each work in conjunction with clamping means 6 and a distribution plate 9.

Both vibration isolators 1 are beam-shaped and consist of an elastic, compressible material, such as for example rubber, synthetic rubber, cork or polyurethane foam. This vibration isolator 1 can be simply obtained by cutting it out of a mat of said elastic, compressible material. Depending on the application, it is possible to select a specific material.

The vibration isolators 1 have a base 4 which is positioned against the base plate 16. On the side 5 situated opposite the base 4, the distribution plate 9 connects onto the vibration isolators 1. During the assembly, the base 4 of the vibration isolators 1 is turned towards the solid ground, whereas the side 5 is turned towards the ceiling, wall and floor plates to be fixed.

Each vibration isolator 1 has a slot 17 formed of a partial cut in the elastic, compressible material of the vibration isolator 1. Consequently, the vibration isolator 1 has a slot side 18 and an opposite, non-cut side 19. Further, the slot 17 divides the vibration isolator 1 in two almost beam-shaped parts, i.e. a first part 2 turned towards the mounting plate 16 and a second part 3 which is turned away from said mounting plate 16. The first part 2 is connected to the second part 3 via a non-cut part of the vibration isolator 1 forming a hinge 15 on the non-cut side 19 of the vibration isolator 1. As the vibration isolator 1 is formed of an elastic, compressible material, the second part 3 can move in relation to the first part 2 through a rotation round the axis 14 of the hinge 15 situated in the plane of the cut.

Thus, it is possible to move the vibration isolators 1 between an open position whereby the second part 3 is turned away from the first part 2 through rotation round the rotation axis 14, as shown in FIG. 3, and a closed position whereby the second part 3 and the first part 2 almost touch, as shown in FIGS. 2, 4 and 5.

In the closed position, the base plate 16, the base 5, the beam-shaped first part 2, the slot 17, the beam-shaped second part 3, the side 5 situated opposite the base 4 and the distribution plate 9 are practically parallel to one another.

The shape and dimensions of the slot 17 are such that the flange 21 or 22 of the supporting profile extending in the longitudinal direction fit therein, at least partially.

The vibration isolators 1 are glued onto the mounting plate 16 with the first part 2 via the base 4, at a certain distance from one another, such that the slots 17 are situated opposite one another and the rotation axis 14 are moved away from each other. The distance between the slots 17 of both vibration isolators 1 and the orientation of these slots 17 are such that the supporting profile 20 can be placed in the assembly element via two opposite flanges 21 and 22 which fit in the respective slots 17.

Each vibration isolator 1 is further provided with clamping means 6 and a distribution plate 9 which work in conjunction to compress the vibration isolators 1 in a closed position between the distribution plate 9 and the ground 30 and/or the base plate 16. The distribution plate 9 is fixed to the second part 3 of the vibration isolator 1 and connects onto the side 5 of the second part 3 of the vibration isolator 1 situated opposite the base 4. The dimensions of the distribution plate 9 preferably practically correspond to the dimensions of the side 5. The clamping means 6 consist, for example, of a screw going through an opening 10 in the distribution plate 9, crosswise through the vibration isolator 1, and which can secure itself in the ground 30 and/or the base plate 16. The clamping means 6 thus push the distribution plate 9 against the second part 3 of the vibration isolator 1 on the one hand, and the clamping means 6 fix the assembly element on the ground 30 on the other hand. As the second part 3 is pushed against the first part 2, the slot 17 will be closed.

In a non-compressed, closed position, the vibration isolator 1 extends over a distance A between the base plate 16 and the distribution plate 9, which are almost parallel in relation to one another according to this first embodiment, as represented in FIGS. 2 and 4. In a compressed, closed position, said distance A is reduced to a distance B between the base plate 16 and the distribution plate 9.

According to the first embodiment of the assembly element, the distribution plate 9 is formed of a flat, rectangular centre part of a U-shaped metal profile whose bent far ends form two rectangular supporting members 7 standing perpendicular to the distribution plate 9.

The supporting members 7 extend as of the distribution plate 9 on either side of the second part 3, in the direction of said second part 3, over a distance C which is smaller than the thickness A of the vibration isolator 1 in a non-compressed, closed position. The sides 8 of the supporting members 7 which are turned away from the distribution plate 9 are almost parallel to the distribution plate 9 and they are meant to rest against the solid ground 30 and/or the base plate 16 as soon as the vibration isolator 1 has the required pre-stress.

When compressing the vibration isolator 1, the distribution plate 9 will move in relation to the base plate 16. Consequently, the distance A will be reduced until the supporting members 7 rest on the ground and/or the base plate 16, such that the vibration isolator 1 is maximally compressed to a thickness B which is almost equal to the length C of the supporting members 7, as shown in FIG. 5.

Consequently, in this first embodiment, the length C of the supporting members 7 determines the minimal distance between the distribution plate 9 and the ground 30 and/or the base plate 16, and thus also the maximal required pre-stress or compression of the vibration isolator 1. When compressed, the supporting members 7 form spacer sleeves between the distribution plate 9 and the base 4, such that a minimal distance between the distribution plate 9 and the base 4 is maintained and a maximal compression of the vibration isolator 1 is determined. Naturally, the thickness of the flanges 21 and 22, which are put in the slots 17, also influences the compression and the thickness A of the vibration isolator 1.

In order to fix the flanges 21 and 22 of a supporting profile 20 in the slots 17 of the vibration isolators 1, they are opened in a first phase so that the supporting profile 20 can be placed freely against the first parts 2 of the vibration isolators 1 with its flanges 21 and 22, as shown in FIG. 3. In a second phase, the vibration isolators 1 are closed then, as a result of which the flanges 21 and 22 are situated in the slots 17 between the first part 2 and the second part 3, as shown in FIG. 4. In a third phase, the clamping means 6 are clamped, such that the distribution plate 9 will be moved to the ground 30 and/or the base plate 16 until the supporting members 7 rest on the ground 30 and/or the base plate 16, as shown in FIG. 5. As a result, the vibration isolators 1 are pre-stressed up to the level which is determined by the supporting members 7. As a result of the pre-stress, the dynamic rigidity of the material is lowered, which improves the vibration isolation.

In a first stage, the assembly element can be fixed to the ground 30 by means of a separate fastening means, after which the supporting profile 20 is fixed to the assembly element by the clamping means 6. As an alternative, the assembly element can be fixed to the supporting profile 20 in a first stage, after which the whole is fixed to the ground 30 by means of the clamping means 6 or by means of a separate fastening means. This separate fastening means may consist of screws, nails, mounting glue or other means known as such to the craftsman.

A second embodiment of the assembly element according to the invention is represented in FIGS. 6 to 7 and, just as the first embodiment, it is designed for fixing a supporting profile 20 having an omega-shaped cross section.

This second embodiment differs from the first embodiment among others in that the first part 2 and the second part 3 of the vibration isolator 1 are two separate parts which are fixed to the assembly element as entirely detached from one another. Thus, the first part 2 and the second part 3 of the vibration isolator 1 may be separate rubber blocks, so that no cut needs to be made. The first part 2 of the vibration isolator 1 is directed towards the ground 30, and a second part 3 is turned away from the ground 30. The slot 17 is formed between the two parts 2 and 3 of the vibration isolator 1. The dimensions of the slot 17 are such that the flange 21 or 22 of the supporting profile 20 extending in the longitudinal direction between both parts 2 and 3 can be placed in the slot 17. These parts 2 and 3 can be simply obtained by cutting them out of a mat of vibration and sound-deadening material.

Further, the base plate 16 is provided with hinges 15 on two opposite far ends onto which the distribution plates 9 are fixed. These hinges 15 cannot be compressed, as opposed to those of the first embodiment.

As in the first embodiment, two vibration isolators 1 are provided at the far ends, at a certain distance from one another, which each consist of a first part 2 and a second part 3. The first parts 2 are clamped on the mounting plate 16 between a hinge 15 and a fastening flange 23 in the mounting plate 16.

As in the first embodiment, the distribution plates 9 are provided with two supporting members 7 which are perpendicular to the latter. The second parts 3 are clamped onto the distribution plates 9, between the supporting members 7, by means of fastening flanges 23 provided in the supporting members 7.

By means of the hinges 15, the vibration isolators 1 can be placed in an open and a closed position. In the closed position, the supporting members 7 are directed towards the mounting plate 16.

The distance between both vibration isolators 1 and the orientation of the slots 17, which are defined by the first parts 2 and the second parts 3, is such that the supporting profile 20 can be placed in the assembly element with two opposite flanges 21 and 22 which fit at least partially in the respective slots 17.

As in the first embodiment, a certain pre-stress is put on the vibration isolators 1 as they are being compressed to a thickness which is determined by the supporting members 7.

The supporting members 7 in this second embodiment differ from the supporting members 7 in the first embodiment in that the sides 8 of the supporting members 7 which are turned away from the distribution plate 9 are bevelled, such that these far ends 8 of the supporting members 7 are inclined in relation to the distribution plate 9 and form an angle α which is smaller than 90° in relation to the plane of the distribution plate 9. The angle α preferably amounts to some 3° to 40°, in particular 5° to 10°.

Thanks to these bevelled far ends 8, the supporting members 7 extend as of the distribution plate 9 in the direction of the second part 3 over a distance C on the side 19 of the hinge 15 and over a distance C′ on the side 18 of the slot 17, whereby the distance C′ is smaller than the distance C, which is smaller then the thickness A of the vibration isolator 1 in a non-compressed, closed position.

As the vibration isolator 1 is being compressed, the distribution plate 9 will move in relation to the base plate 16. As a result, the distance A is reduced until the supporting members 7 rest on the ground 30 and/or on the base plate 16, such that the vibration isolator 1 is maximally compressed to a thickness B and B′ respectively, which is almost equal to the length C and C′ respectively of the supporting members 7, as shown in FIG. 7.

In this compressed condition, the distribution plate 9 forms an angle α with the base plate 16, which is smaller than 90° and preferably amounts to 3° to 40°, as a result of which the compression of the vibration isolator 1 will increase in the direction of the decreasing distance between the distribution plate 9 and the base plate 16.

In this second embodiment, the length C to C′ of the supporting members 7 determines the minimal distance between the distribution plate 9 and the base 4 which connects onto the ground 30 and/or the base plate 16. Consequently, the vibration isolator 1 is compressed over a distance which is practically equal to the difference between the thickness A of the non-compressed vibration isolator 1 and the length C and C′ respectively of the supporting members 7, such that the supporting members 7 determine the maximal compression or pre-stress of the vibration isolator 1.

Consequently, when compressed, the distribution plate 9 forms an angle α with the base 4, the base plate 16 and/or the solid ground 30, such that the pre-stress of the vibration isolator 1 increases in the direction of the decreasing distance between the distribution plate 9 and the base 4.

Thanks to this construction, the compression of the vibration isolator 1 gradually increases as of the hinge 15 on the side 19 towards the slot side 18. As a consequence, the pressure on the flange 21 or 22 in the slot 17 also increases towards the slot side 18 in the cross direction of the supporting profile 20. As a result, the dynamic rigidity of the system is reduced, which improves the vibration insulation.

A third embodiment of the assembly element according to the invention is not represented in the figures and merely differs from the first or second embodiment in that only one of both vibration isolators 1 is provided with a distribution plate 9 and clamping means 6. A first vibration isolator 1 is provided with a slot 17 which, as in the first and second embodiments, is designed for fixing a first longitudinal flange 21 of the supporting profile 20 having an omega-shaped cross section. Instead of the second vibration isolator 1, a vibration isolator 1′ has been provided, equipped with a slot 17′ in which the second longitudinal flange 22 can take place, such that the latter is acoustically insulated from the ground 30 as well. This second vibration isolator 1′ is not provided with a distribution plate 9, nor with any clamping means 6. This variant of the assembly element is designed to be fixed to the ground 30 with merely one clamping element 6. The first longitudinal flange 21 is situated inside the slot 17 and it is clamped by the vibration isolator 1 as said vibration isolator 1 standing perpendicular to the flange 21 is being compressed and thus closes the slot 17 in which the flange 21 is situated. The second flange 22 is situated inside a slot 17′ of the second vibration isolator 1′ and it is pushed in the slot 17′ as the first slot 17 with the first flange 21 therein is being compressed.

A fourth embodiment of the assembly element according to the invention is not represented in the figures and differs from the first embodiment in that the thickness A of the non-compressed vibration isolators 1 is larger on the slot side 18 than on the side 19 turned away from the latter. As a result, the vibration isolator 1 will have to be compressed further on the slot side 18 than on the side 19 in which the hinge 15 is situated, such that the pre-stress increases as of the side 19 towards the slot side 18.

A fifth embodiment of the assembly element according to the invention is not represented in the figures and differs from the first embodiment in that, in the closed position, the base plate 16 is inclined in relation to the distribution plate 9, such that the distance between the base plate 16 and the distribution plate 9 is smaller on the slot side 18 than on the opposite side 19 of the vibration isolator 1. If moreover the thickness A of the non-compressed vibration isolators 1 is equally large on the slot side 18 as on the side 19, the vibration isolators 1 will be compressed further on the slot side 18 than on the side 19.

A sixth embodiment of the assembly element according to the invention merely differs from the preceding embodiments in that it does not comprise a hinge 15 but a sliding element which makes it possible for the second part 3 to undergo a translation in relation to the first part 2. Possibly, the second part 3 with the distribution plate 9 may be fixed on the first part 2 in a detachable manner, as is represented for example in the embodiment of FIG. 19. In FIG. 19a, the second part 3 is provided with a distribution plate 9 with supporting members 7 extending round the second part 3. FIG. 19b shows a variant whereby no supporting member 7 is provided. Clamping means 6 are further provided which consist of a screw extending crosswise through the distribution plate 9, the second part 3 and the first part 2 of the vibration isolator 1. The supporting members 7 and/or the clamping means 6 serve as a sliding element in this case.

A seventh embodiment of the assembly element according to the invention is not represented in the figures and differs from the preceding embodiments in that the supporting members 7 are provided on the base plate 16. These supporting members 7 extend as of the base plate 16 over a length C and/or C′ in the direction of the first part 2 of the vibration isolator 1. In the closed, compressed condition of the vibration isolator 1, the supporting members 7 rest on the distribution plate 9.

An eighth embodiment of the assembly element according to the invention is not represented in the figures and merely differs from the preceding embodiments in that it does not comprise a base plate 16. The vibration isolators 1 are hereby fixed with the base 4 directly on the ground 30. Preferably, the first parts 2 of both vibration isolators 1 are formed in one piece, such that both vibration isolators 1 have a common first part.

A ninth embodiment of the assembly element according to the invention, represented in FIGS. 8 and 9, differs from the second embodiment in that the first parts 2 of the vibration isolators 1 are formed of only one piece 2′ onto which the two second parts 3 may connect. As a consequence, the vibration isolators 1 have a common first part 2′.

This common first part 2′ is fixed to a base plate 16. The dimensions of the common first part 2′ are such that both flanges 21 and 22 of a supporting profile 20 can rest on it. According to this specific embodiment, shown in FIGS. 8 and 9, the outer edges of these flanges 21 and 22 do not rest on the part 2′. As such, the first part 2′ and the second parts 3 do not touch each other when the flanges 21 and 22 of the profile 20 are present in the slots 17. However, it is also possible for this common first part 2′ of the vibration isolators 1 to extend on either side of the supporting profile 20 past the flanges 21 and 22.

One of the advantages compared to for example the second embodiment is that the vibration isolators 1 in the assembly element are only composed of three components in total. Further, the common part 2′ may have a thickening 2′ extending between the flanges 21 and 22 in the cavity 24 of the supporting profile 20, as shown in FIG. 10. This prevents the supporting profile 20 from bending for example in its longitudinal direction when being loaded and it prevents the flanges 21 and 22 from being drawn out of the slots 17.

A tenth embodiment of the assembly element according to the invention is represented in FIGS. 11 and 12 and merely differs from the second embodiment in that the base plate 16 does not continue between the two first parts 2 of the vibration isolators 1. Consequently, the vibration isolators 1 are not connected to one another. The assembly element consists of a set of two analogous elements which can each enclose a flange of the supporting profile 20. The disadvantage with this embodiment, however, is that the distance between the slots 17 is not fixed. This implies a risk in that, when the flanges 21 and 22 of the supporting profile 20 are fixed in the wrong way, they will not be clamped sufficiently deep in the slots 17.

In order to prevent this, however, the first parts 2 of the vibration isolators 1 may have a standing edge 25, as shown in FIG. 14, extending in the cavity 24 of the supporting profile 20 between the flanges 21 and 22. The standing edge 25 may be formed of a third part which connects onto the first part 2.

An eleventh embodiment, represented in FIG. 15, differs from the second embodiment in that a central fastening point 26 is provided in the base plate 16 on the one hand, and the clamping means 6 consist of a snap-in system provided on the distribution plate 9 on the other hand. In contrast with the first embodiment, the clamping means 6 in this embodiment do not serve to fix the assembly element to the ground 30 either. Via the fastening point 26, the element can be fixed to the ground 30 with means known as such, such as screws. The fastening point can also be provided on one or both far ends of the distribution plate 16. The snap-in system fixes the distribution plate 9 to the base plate 16, such that they are situated at a pre-determined distance from one another. The snap-in system may for example consist of a recess in the base plate 16 in which a standing far end of the distribution plate can mesh. Advantageously, the snap-in system can be provided on the supporting members 7.

A twelfth embodiment is represented in FIGS. 16 to 18. This embodiment differs from the first embodiment in that no base plate 16 is provided and in that the vibration isolators 1 are formed in one piece. The first parts 2 form a common part 2′ which extends over both flanges 21 and 22 of the supporting profile 20. The second parts 3 of the vibration isolators 1 are connected to the far ends of the common part 2′ by means of a flexible hinged joint 15, as in the first embodiment. This embodiment could possibly be realised without any supporting elements 7, as shown in FIG. 15, and/or the second parts 3 of the vibration isolators 1 may be detached from the common first part 2′, as shown in FIG. 19.

A thirteenth embodiment is represented in FIGS. 20 and 21. This embodiment differs from the second embodiment in that the base plate 16 is interrupted between the two first parts 2 of the vibration isolators 1. Said two first parts 2 are made of one and the same piece 2′ instead. This common part 2′ can thus extend, at least partially, over both flanges 21 and 22 of the supporting profile 20. Thus, the parts of the interrupted base plate 16 are connected to one another by means of the common part 2′ of the vibration isolators 1.

The common part 2′ may possibly be provided with a thickening 24 which is designed to extend in the cavity 24 of the supporting profile 20, between the flanges 21 and 22, as shown in FIG. 21. This thickening 24 prevents the supporting profile 20 from being transformed when it is loaded, and, as such, it prevents the flanges 21 and 22 from being moved towards one another, as a result of which they are drawn out of the slots 17.

Naturally, the invention is not restricted to the above-described embodiment represented in the accompanying drawings; on the contrary, more variants may be considered within the scope of the invention.

Thus, the vibration isolator 1 can be made of different sorts of vibration and sound-deadening material available to the craftsman, and said vibration isolators 1 may be formed of several parts or layers of elastic, compressible material.

Thus, several above-described elements such as the distribution plate 9, the base plate 16 or the supporting members 7 can be made of synthetic material.

Thus, instead of two supporting members 7, only one supporting member 7 may be provided. Or also more than two supporting members 7 per vibration isolator 1 can be provided. Thus, the supporting member 7 can be put crosswise through the vibration isolator 1. Thus, the supporting member 7 can co-operate directly with the clamping means 6, as they are fixed for example on the clamping means 6 and can lock the clamping means when the vibration isolator 1 is at least partly compressed.

Thus, in all the embodiments, the vibration isolators 1 can be fixed either by means of fastening flanges 23, by means of glue, or by means of other means known as such, such as clamps, screws or staples. However, it is not necessary for the vibration isolators 1 to be fixed in the assembly element. Thus, the different components may also be separate parts which are fixed to one another during the assembly by means of for example the clamping means 6.

Thus, the above-described hinges 15 may consist of a point of rotation which connects the first part 2 or 2′ to the second part 3.

Thus, the orientation and dimensions of the slots 17 may be adjusted, such that all sorts of supporting profiles 20 can be fixed with the assembly element. Thus, said supporting profiles 20 may for example also have a T-shaped, I-shaped or H-shaped cross section.

Finally, intermediary embodiments can be developed which combine elements of the different specific embodiments and thus form workable assembly elements according to the invention. The supporting members 7 as described in the different specific embodiments can for example be mutually switched in these embodiments, such that the resulting maximal compression of the vibration isolator 1 allows for a rise of the pre-stress in the vibration isolator 1 towards the slot side 18. Further, any possible other element such as a variable thickness of the vibration isolator 1 can also be combined with elements from other embodiments.

1. Assembly element for fixing a supporting profile (20) on a solid ground (30) with at least two opposite, outward turned flanges (21, 21) extending in the longitudinal direction of said supporting profile (20),
whereby this assembly element comprises at least one elastic, compressible vibration isolator (1) with a slot (17) designed to receive a flange (21, 22) of the supporting profile (20), such that the supporting profile (20) is acoustically insulated in relation to the ground (30), whereby
(i) the vibration isolator (1) consists of at least two parts (2, 2′, 3) which define said slot (17) and which enable the vibration isolator (1)
to assume an open position, whereby said parts (2, 2′, 3) of the vibration isolator (1) are at least partly removed from one another so as to put a flange (21, 22) of the supporting profile (20) at least partly in the slot (17), and
to assume a closed, compressed position, whereby said parts are moved towards one another and the vibration isolator (1) is compressed so as to close the slot (17) when a flange (21, 22) of the supporting profile (20) is situated at least partly in the slot (17), such that the flange (21, 22) is clamped in the slot (17),
(ii) the assembly element has a base (4) with which it rests on said ground (30) and which connects onto a first one of said parts (2, 2′), and
(iii) the assembly element has a distribution plate (9) on the side (5) opposite said base (4), whereby the distribution plate (9) connects onto a second one of said parts (3), such that said parts (2, 2′, 3) extend at least partly between said base (4) and the distribution plate (9) and, in said closed, compressed position, are compressed between the base (4) and the distribution plate (9) by means of clamping means (6)
(iv) the assembly element comprises at least two vibration isolators (1) whose slots (17) are situated opposite one another and are turned towards one another so that, in the closed position, they at least partly enclose both said flanges (21, 22) of the supporting profile (20).

2. Assembly element according to claim 1, whereby the assembly element comprises a hinge (15) between said parts (2, 2′, 3) of the vibration isolator (1), as a result of which they rotate in relation to one another over an axis (14) from the open position into the closed position and vice versa.

3. Assembly element according to claim 1, whereby the base (4) at least partly consists of a base plate (16) which co-operates with the distribution plate (9) so as to compress the vibration isolator (1) between the distribution plate (9) and the base plate (16) by means of the clamping means (6).

4. Assembly element according to claim 3, whereby the base plate (16) connects the two vibration isolators (1) to one another.

5. Assembly element according to claim 3, whereby the clamping means (6) extend crosswise through the distribution plate (9), the vibration isolator (1) and the base plate (16) into the ground (30).

6. Assembly element according to claim 1, whereby it is provided with a supporting member (7) extending between the distribution plate (9) and the base (4) and, when the vibration isolator (1) is at least partly compressed, forms a spacer sleeve between the distribution plate (9) and the base (4), such that the distribution plate (9) cannot be moved any further to the base (4).

7. Assembly element according to claim 6, whereby the supporting member (7) extends over a certain length (C) as of the distribution plate (9) in the direction of the base (4) of the vibration isolator (1) such that, in the closed, compressed position of the vibration isolator (1), the supporting member (7) rests on the ground (30) and/or the base plate (16).

8. Assembly element according to claim 1, whereby the vibration isolator (1) has a slot side (18) via which the flange (21, 22) of the supporting profile (20) is at least partly introduced in the slot (17), and whereby in the closed, compressed position of the vibration isolator (1), the compression gradually increases towards the slot side (18).

9. Assembly element according to claim 1, whereby the distribution plate (9), in the closed, compressed position, extends slantingly in relation to the base (5) of the vibration isolator (1), as a result of which the compression of the vibration isolator (1) increases in the direction of the decreasing distance between the distribution plate (9) and the base (5) of the vibration isolator (1).

10. Assembly element according to claim 9, whereby the edge (8) of the supporting member (7) to be directed towards the solid ground (30) forms an angle (α) with the distribution plate (9) which is smaller than 90° and preferably amounts to 3° to 40°.

11. Assembly element according to claim 1, whereby the clamping means (6) extend crosswise through the distribution plate (9) and the vibration isolator (1) into the ground (30).

12. Assembly element according to claim 1, whereby said first part (2, 2′) of the vibration isolator (1) extends at least partly in a cavity (24) of the supporting profile (20) between the flanges (21, 22) of this supporting profile (20) when said supporting profile (20) is fixed to the ground (30) with the assembly element.

13. Assembly element according to claim 1, whereby said first parts (2) of the vibration isolators (1) form at least a common part (2′) which connects onto the base (4) and which, together with the second parts (3) of the vibration isolators (1), form said opposite slots (17).

14. Assembly element according to claim 13, whereby said vibration isolators (1) are made in one piece.

15. Method for fixing a supporting profile (20) to a ground (30) with two flanges (21, 22) which are turned away from one another and which extend in the longitudinal direction of the profile (20),
whereby use is made of an assembly element with a base (4) which rests on the ground (30),
whereby the flanges (21, 22) of the supporting profile (20) are placed against a side which is turned away from the base (4) of a first part (2, 2′) of at least two vibration isolators (1) which are made of elastic, compressible material,
after which a second part (3) of the vibration isolators (1) is placed at least partly against the flanges (21, 22) so that at least two slots (17) are formed between the first and second parts (2, 2′, 3) of the vibration isolators (1) in which the flanges (21, 22) are at least partly situated,
whereby the vibration isolators (1) are compressed by moving a distribution plate (9) which connects onto the second part (3) on a side (5) of the vibration isolator (1) which is turned away from the base (4) towards the base (4) by means of clamping means (6).

16. Method according to claim 15 whereby, in order to form the slot (17), the second part (3) of the vibration isolators (1) is rotated in relation to the first part (2, 2′) over a hinge (15) connecting the first part (2, 2′) to the second part (3).

17. Method according to claim 15, whereby at least one vibration isolator (1) is compressed until a supporting member (7) rests between the distribution plate (9) and the ground (30) or the base (4), such that the distribution plate (9) cannot be moved any further towards the base (4) and the vibration isolator (1) cannot be compressed any further.

18. Method according to claim 15, whereby at least one vibration isolator (1) is gradually compressed harder towards the flanges (21, 22) and as of an outer edge of the flanges (21, 22) towards a central longitudinal axis of the profile (20).

19. Method according to claim 15, whereby two flanges (21, 22) of a profile (20) with an omega-shaped cross section extending in the longitudinal direction are clamped in the slots (17) of opposite vibration isolators (1) of an assembly element.
